(19) United States
(12) Patent Application Publication
(10) Pub. No.: US 2026/0040102 A1
(43) Pub. Date: Feb. 5, 2026

(54) Methods for Interoperable AI/ML Model Training Using Task Based Regularization

(71) Applicant: InterDigital Patent Holdings, Inc., Wilmington, DE (US)

(72) Inventors: Akshay Malhotra, San Jose, CA (US); Yugeswar Deenoo Narayanan Thangaraj, Chalfont, PA (US); Mohamed Salah Ibrahim, Chesterbrook, PA (US)

(73) Assignee: InterDigital Patent Holdings, Inc., Wilmington, DE (US)

(21) Appl. No.: 18/794,982

(22) Filed: Aug. 5, 2024

(51) Int. Cl. H04W 24/08

(52) U.S. Cl. CPC H04W 24/08

(57) ABSTRACT

A wireless transmit/receive unit (WTRU) may receive configuration information from a network. The configuration information may include a task associated with a WTRU-side model and a performance metric threshold related to the task. The WTRU may train a WTRU-side model for performing a use case based on regularization using the task. The WTRU may determine that the performance metric threshold is met by the WTRU-side model on the task. The WTRU may further send, to the network, an indication of the task based on the performance metric threshold being met by the WTRU-side model on the task.

### BACKGROUND

Channel State Information, which may include at least one of the following: channel quality index (CQI), rank indicator (RI), precoding matrix index (PMI), an L1 channel measurement (e.g., reference signal received power (RSRP) such as L1-RSRP, or signal-to-interference-plus-noise ratio (SINR)), channel state information reference signal (CSI-RS) resource indicator (CRI), SS/PBCH block resource indicator (SSBRI), layer indicator (LI) and/or any other measurement quantity measured by the WTRU from the configured reference signals (e.g. CSI-RS or SS/PBCH block or any other reference signal).

### SUMMARY

Methods for interoperable AI/ML model training using task based regularization are described herein. A wireless transmit/receive unit (WTRU) may receive configuration information from a network. The configuration information may include a task associated with a WTRU-side model and a performance metric threshold related to the task. The WTRU may train a WTRU-side model for performing a use case based on regularization using the task. The WTRU may determine that the performance metric threshold is met by the WTRU-side model on the task. The WTRU may further send, to the network, an indication of the task based on the performance metric threshold being met by the WTRU-side model on the task.

In one example, the task associated with the WTRU-side model may include a supervised or unsupervised task that is performed on one or more data sets, a self-supervised tasks that is associated with a structure being applied to the channel, or a compression task associated with a reference encoder or a reference decoder.

The task may be associated with a logical identification, a model, a regularization factor, or a loss function associated with regularization. The task may be a function that takes a latent space as an input of the WTRU-side model and produces an output function to the WTRU-side model. The output function may be based on the input.

In one embodiment, the task may include channel parameter estimation, multipath estimation, beam selection, or beamforming estimation. The use case may include CSI compression.

The performance metric threshold may include a NMSE threshold, a SGCS threshold, a classification accuracy threshold, or a key performance indicator (KPI) threshold (e.g., a minimum performance threshold for each metric associated with each task).

The configuration information may include an indication of a plurality of datasets that can be used for training the WTRU-side model. The WTRU may send, to the network, an indication of a dataset of the plurality of datasets that was used when the performance metric threshold is met by the WTRU-side model on the task.

In another example, the use case may include CSI compression, and the WTRU may determine an encoded channel matrix in a latent space, determine a quantized channel matrix, and send a report to a network. The report may indicate the quantized channel matrix as compressed CSI feedback.

The WTRU may also determine that the performance metric threshold is met by the WTRU-side model on the task based on measured CSI feedback and the compressed CSI feedback (e.g., the quantized channel matrix).

The WTRU may trigger a performance monitoring report, a fallback, or a model switching if the performance of the WTRU-side model on the task is less than the performance metric threshold.

In another embodiment, the task may be configured to perform a transformation of a latent space to a different domain.

The determination that the performance metric threshold may be met by the WTRU-side model on the task, where the WTRU may determine that the performance metric threshold is met by a combination of the WTRU-side model and an additional WTRU-side model on the task.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example illustrating an example configuration for CSI reporting settings, resource settings, and link.

FIG. 3 is a diagram illustrating an example of how a wireless transmit/receive unit (WTRU) and a network (NW) can train their respective encoder-decoder model with a reconstruction loss and a task related loss.

### DETAILED DESCRIPTION

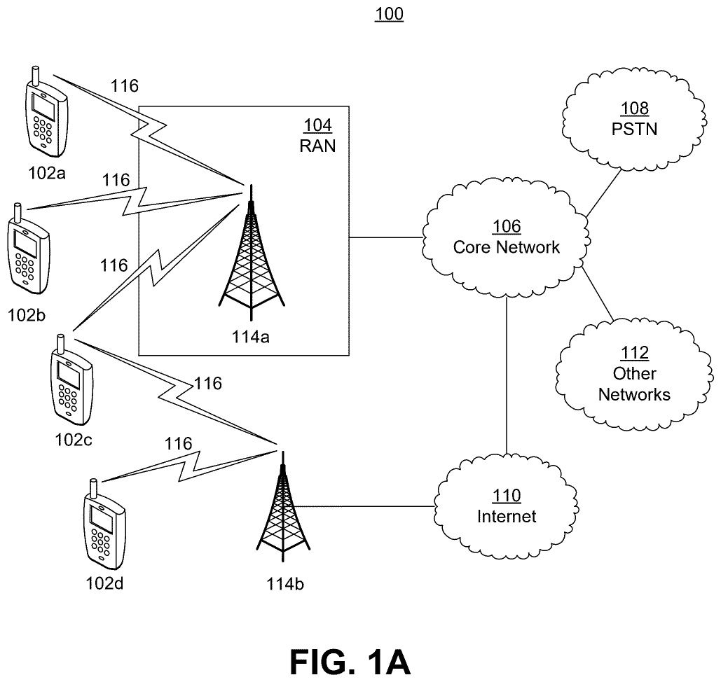

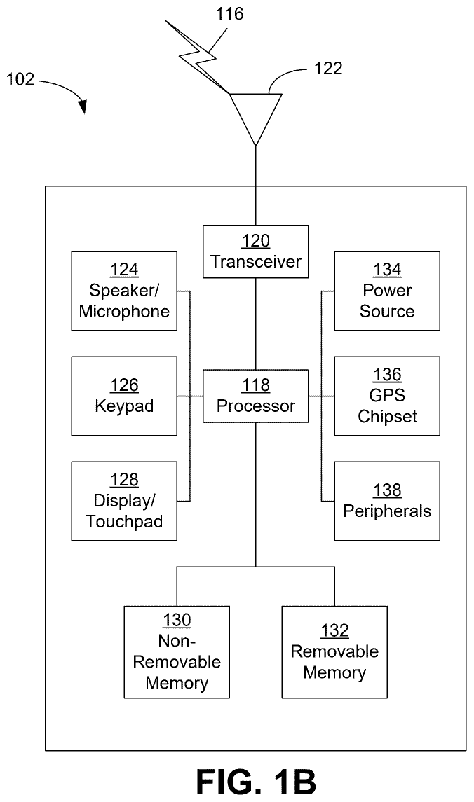

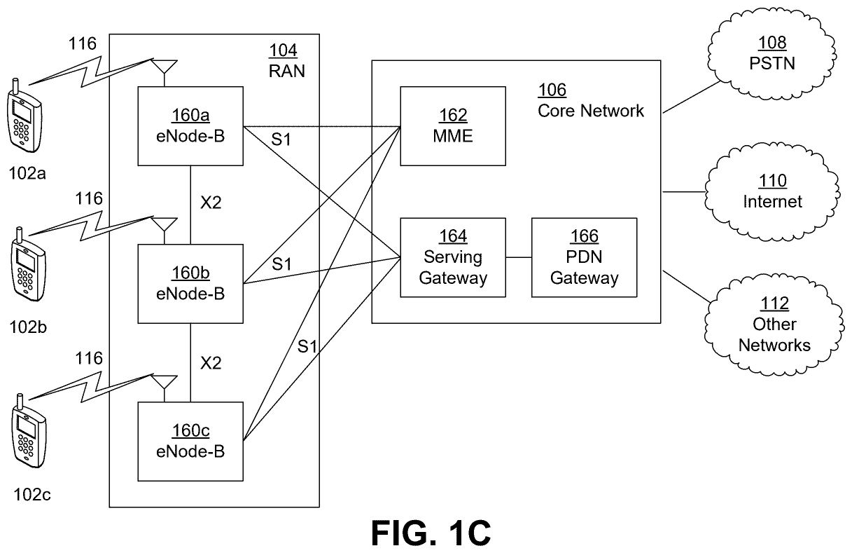

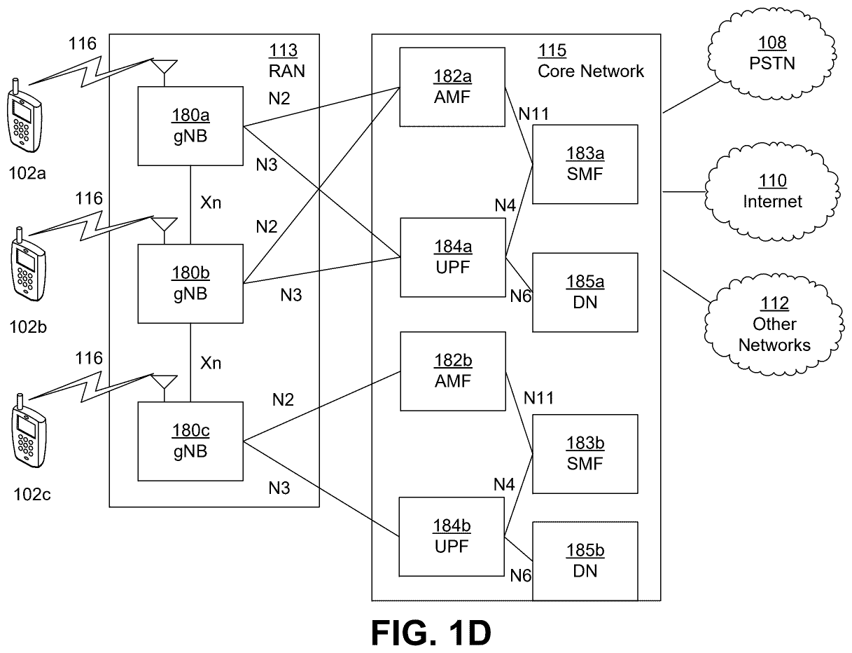

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more functions while being fully or partially implemented and/or deployed as part of a wired and/or wireless communication network in order to test other devices within the communication network. The one or more emulation devices may perform the one or more functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The WTRU may be configured to report the CSI through the uplink control channel on physical uplink control channel (PUCCH), or per the gNBs' request on an uplink (UL) physical uplink shared channel (PUSCH) grant. Depending on the configuration, CSI-RS can cover the full bandwidth of a BandWidth Part (BWP) or just a fraction of it. Within the CSI-RS bandwidth, CSI-RS can be configured in each physical resource block (PRB) or an other PRB. In the time domain, CSI-RS resources can be configured either periodic, semi-persistent, or aperiodic. Semi-persistent CSI-RS is similar to periodic CSI-RS, except that the resource can be (de)-activated by medium access control (MAC) control elements (CEs); and the WTRU may report related measurements when the resource is activated. For Aperiodic CSI-RS, the WTRU is triggered to report measured CSI-RS on PUSCH by request in a downlink control information (DCI). Periodic reports are carried over the PUCCH, while semi-persistent reports can be carried either on PUCCH or PUSCH. The reported CSI may be used by the scheduler when allocating optimal resource blocks possibly based on channel's time-frequency selectivity, determining precoding matrices, beams, transmission mode and selecting suitable modulation and coding schemes (MCSs). The reliability, accuracy, and timeliness of WTRU CSI reports may be critical to meeting ultra reliable low latency communication (URLLC) service requirements.

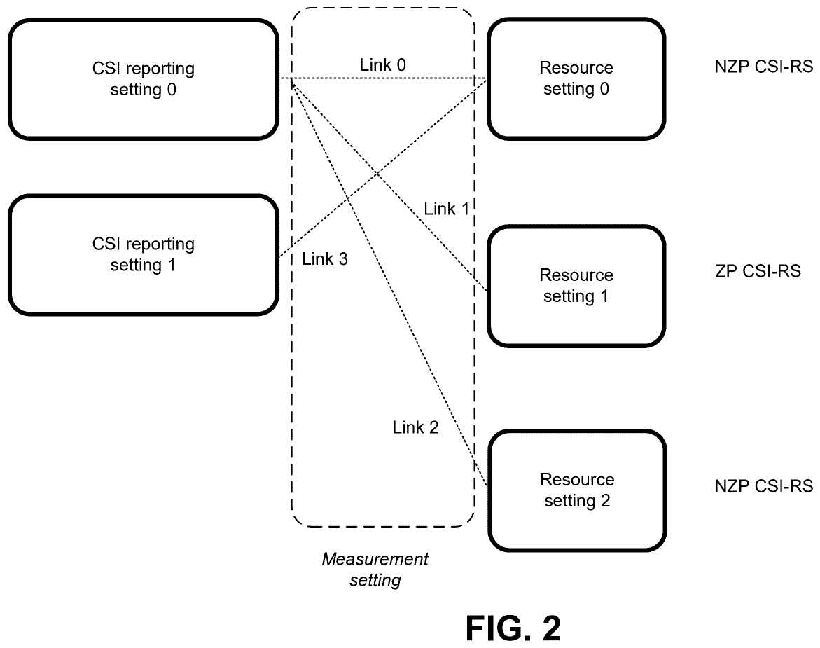

The WTRU may be configured with a CSI measurement setting which may include one or more CSI reporting settings, resource settings, and/or a link between one or more CSI reporting settings and one or more resource settings. FIG. 2 shows an example of a configuration for CSI reporting settings, resource settings, and link.

In a CSI measurement setting, one or more of the configuration parameters may be provided. One or more of the configuration parameters may be N is more than or equal to CSI reporting settings, M is more than or equal to 1 resource settings, and a CSI measurement setting which links the N CSI reporting settings with the M resource settings.

A CSI reporting setting may include one or more of time-domain behavior, frequency-granularity, CSI reporting type, and/or PMI type and codebook configuration if a PMI is reported. Time-domain behavior may be aperiodic or periodic/semi-persistent. Frequency-granularity may be at least for PMI and/or CQI. CSI reporting type may be a PMI, a CQI, an RI, and/or a CRI. A PMI type may be Type I or Type II.

A resource setting may include one or more of time-domain behavior, an RS type, S being more than or equal to one resource set(s), and/or each resource set containing Ks resources. The time-domain behavior may be aperiodic or periodic/semi-persistent. An RS type may be for channel measurement or interference measurement.

A CSI measurement setting may include one or more of one CSI reporting setting, one resource setting, and/or for CQI, a reference transmission scheme setting. For CSI reporting for a component carrier, one or more frequency granularities may be supported. One or more frequency granularities may be a wideband CSI, a partial band CSI, and/or a sub band CSI.

Artificial intelligence may be broadly defined as the behavior exhibited by machines. Examples of such behaviors may be to mimic cognitive functions to sense, reason, adapt and/or act. The terms Artificial Intelligence (AI), Machine Learning (ML), Deep Learning (DL), deep neural networks (DNNs) may be used interchangeably. Methods described herein are exemplified based on learning in wireless communication systems. The methods may not be limited to such scenarios, systems and/or services. The methods may be applicable to any type of transmissions, communication systems and/or services.

Auto-encoders (AE) may be specific class of deep neural networks (DNNs) that arise in context of un-supervised machine learning setting wherein the high-dimensional data is non-linearly transformed to a lower dimensional latent vector using the DNN based encoder and the lower dimensional latent vector is then used to re-produce the high-dimensional data using a non-linear decoder. The encoder may be represented as E(x; Wₑ) where x is the high-dimensional data and Wₑ represents the parameters of the encoder. The decoder may be represented as D(z; W_{d}) where z is the low-dimensional latent representation and W_{d} represents the parameters of the decoder. Further, using training data {x₁, . . . , x_{N}} the auto-encoder may be trained by solving the optimization problem of

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem may be approximately solved using backpropagation algorithm. The trained encoder

$$E ( x ; {W}_{e}^{tr} )$$

may be used to compress the high-dimensional data and trained decoder

$$D ( z ; {W}_{d}^{tr} )$$

may be used to decompress the latent representation.

Existing methods for training of 2 sided models (like auto-encoders) either may require that the 2 models (encoder and decoder) are both present at the same compute entity for the training process or may require high amounts of data transfer to accomplish the training. The first set of methods that rely on training at the same compute entity that are restrictive as the 2-sided models (like encoders and decoders) may be usually deployed at 2 different entities (like WTRU and gNB, respectively). Thus, ensuring that the model is available for training at a single entity may end up disclosing the proprietary model details (e.g., such as architecture and/or type of layers) of either the WTRU or gNB. In the second set of training methods, the 2 models may be hosted at their respective entities, where large amount of data transfer is required either for the gradient flow at each training step or for sharing the raw and encoded data pairs. Such large quantities of data transfer may be prohibitive for the training process by making the training process virtually impractical. This training method may also have the restriction that the training is done sequentially (e.g., first at gNB and at WTRU or vice versa) which is not easily extendible to a multi-vendor setting.

Task based interoperability is described herein. Method for training 2-sided model (e.g., for CSI compression) where the WTRU trains the WTRU-side model (NW trains the NW-side model) independently to satisfy a preconfigured performance condition may be described herein. WTRU/NW may achieve interoperability for inference by utilizing a task-based regularization during the model training. WTRU may use the task-based regularization for interoperability and/or performance monitoring.

The WTRU may be configured with a plurality of datasets, one or more tasks, performance metric/requirement for each task, and/or model related parameters. Each dataset in the plurality of datasets may be associated with one or more of deployments, vendors, and/or WTRU/NW additional condition. For example, each dataset may be associated with a Dataset ID. Each dataset may be associated with one or more applicable conditions. Each dataset may be configured as distribution of parameters (e.g., each dataset may be expressed as fundamental channel parameters, like decomposed channel, and expressed in terms of 3GPP channel model parameters like UMa/CDL/etc., doppler, and/or delay). The configuration information may include an indication of a plurality of datasets that can be used for training the WTRU-side model. The WTRU may send, to the network, an indication of a dataset of the plurality of datasets that was used when the performance metric threshold is met by the WTRU-side model on the task. The determination that the performance metric threshold is met by the WTRU-side model on the task may include to determine that the performance metric threshold is met by a combination of the WTRU-side model and an additional WTRU-side model on the task.

A single task T1 or a set of tasks [T1, T2, . . . TN] maybe utilized for WTRU side model training. The task may be a generic/reference task that can be performed with the data. For example, for the CSI case, the task may be channel parameter estimation, multipath estimation, beamforming, channel charting etc. Examples of self-supervised tasks may be adding doppler phase shifts for a WTRU speed to channel and predicting the doppler shift or WTRU speed. Compression may be considered as the task. For example, a proxy/reference auto-encoder, or reference encoder or a reference decoder may be pre-trained for compression. A task may be associated with a WTRU side model. The task may be included in configuration information received from a network. The task associated with the WTRU-side model may include a reference task that is performed on one or more data sets, a self-supervised tasks that is associated with a structure being applied to the channel, or a compression task associated with a reference encoder or a reference decoder.

Each task Ti may be accompanied with a logical identification, a model Mᵢ, a regularization factor λᵢ, and/or a loss function Lᵢ for the regularization. The model may be pre-trained or may be trained along with the auto-encoder training.

Each task may be further associated with a subset of the dataset, such that the task Ti is used for training with samples corresponding to the subset Aᵢ⊂A, where A is the complete dataset. For each task Ti, the WTRU may be also configured with the training output labels corresponding to Aᵢ or an algorithm to obtain labels using Aᵢ. For each task, the model Mᵢ may be pre-trained or maybe trained along with the training of the encoder model. The task may be associated with a logical identification, a model, a regularization factor, or a loss function associated with regularization. The task may be a function that takes a latent space as an input and outputs an output function. The output function may be based on the input. The task may include channel parameter estimation, multipath estimation, or beamforming estimation.

The WTRU may be configured with performance metric/requirement for each task, like a key performance indicator (KPI). A task may be associated with a performance metric threshold related to the task. Examples of metric for performance of each of the Ti tasks may be normalized mean square error (NMSE), squared generalized cosine similarity (SGCS), and/or classification accuracy. A KPI may be a minimum performance threshold for each metric associated with each task.

The WTRU may be configured with model related parameters. Examples of model related parameters may be latent dimension, loss function for auto-encoding, and/or performance metric/requirement for each task. Examples of a metric for performance of the autoencoder may be normalized mean square error (NMSE), squared generalized cosine similarity (SGCS), etc. A KPI may be a minimum performance threshold for each metric. The performance metric threshold may include a NMSE threshold, a SGCS threshold, a classification accuracy threshold, or a key performance indicator (KPI) threshold (e.g., a minimum performance threshold for each metric associated with each task).

The WTRU may train AIML model based on task-based regularization. The WTRU may train a WTRU-side model for performing a use case based on regularization using the task. The use case may include a CSI compression. The WTRU may train its encoder model directly with the task-based model, or the WTRU may train the encoder with another decoder model while also using the task-based model regularization. For example, in the case of a generic task. The WTRU may also update or train the task-based models along with encoder training. Examples of the WTRU may train its encoder model directly with the task-based model are described herein. For example, if the refence task is a decoder model, direct training with reference decoder may be performed. In this example, a loss function may be

$$\frac{1}{N 1} {\sum }_{i = 1 : N 1} {{\vert ( {R}^{D} ( {E}_{1} ( {H}_{i} ) ) - ( {H}_{i} ) ) \vert}_{F}}^{2} .$$

In another example, if the reference task is a reference encoder, direct training may be performed to minimize the loss in latent space. In this example, a loss function may be

$$\frac{1}{N 1} {\sum }_{i = 1 : N 1} {{\vert ( {E}_{1} ( {H}_{i} ) - {R}^{E} ( {H}_{i} ) ) \vert}_{F}}^{2} .$$

For example, if the reference task is an auto-encoder (REF_AE), the WTRU may train its encoder model directly with the task-based model to directly minimize the loss between (AE(H)−REF_AE(H)).

The WTRU may transmit an indication related to compatibility (e.g., or interoperability info in model identification) of WTRU side model with respect to NW side models. The indication may include identity of one or more tasks used for regularization during the WTRU side model training, identity of datasets used for training the WTRU-side model, identity of test case(s) on which the WTRU-side model performance was validated (e.g., where the WTRU may send reconstruction minimum performance thresholds corresponding to the test samples), and/or identity of reference model(s) used for regularization during WTRU side model training. For each of the tasks, the WTRU may send the output of the task-based model for a predefined performance test dataset. The NW may compare and determine if the WTRU output is similar to the NW output. The WTRU may send the updated or trained task-based model to the NW where the NW may compare the WTRU side task-based model with its own task-based model either directly or the outputs of these models. The WTRU may report the training strategy (e.g., or any deviations from the training strategy). The training strategy may include task training, and/or decoder training. The train strategy or deviations from the training strategy may include tasks used for training and for how many steps/updates. The WTRU may determine that the performance metric threshold is met by the WTRU-side model on the task. The WTRU may send an indication of the task based on the performance metric threshold being met by the WTRU-side model on the task to the network.

Upon activation of AIML model for inference, during each reporting instance (e.g., CSI feedback), the WTRU may derive encoded input Hᵢ (e.g., Channel matrix) in latent space like E(Hᵢ), the WTRU may apply preconfigured quantization to the encoded representation E(Hᵢ), and/or the WTRU may report the quantized representation as compressed CSI feedback. The WTRU may determine an encoded channel matrix in a latent space. The WTRU may determine a quantized channel matrix. The WTRU may send a report to a network, and/or the report may indicate the quantized channel matrix as compressed CSI feedback. The WTRU may determine that the performance metric threshold is met by the WTRU-side model on the task based on measured CSI feedback and the compressed CSI feedback (e.g., the quantized channel matrix).

The WTRU may do performance monitoring based on preconfigured task(s). The WTRU may use the actual CSI sample and the compressed representation to measure the task performance. The WTRU may trigger performance monitoring report/Fallback/Model switching if the task performance is lower than a threshold, or if the performance of the WTRU-side model on the task is less than the performance metric threshold.

Implementations described herein may contain various benefits. Implementations described herein may avoid drawbacks of the current training methods, where the encoder-decoder models either need to be trained together, or large amounts training data or gradient data transfer has to be undertaken.

In the implementations described herein, the WTRU side and NW side models may be independently trained, and interoperability between the 2 models may be ensured with minimal or no data exchange.

There may be no constraints on the model architecture, loss functions or any training parameters. Further, for a 2-sided model (e.g., such as an encoder-decoder), no prior knowledge (e.g., or coordination) about the model architecture, and/or other training parameters may be needed.

If the task-based models and the related parameters are pre-defined as part of the standards, no data exchange may be needed to ensure interoperability. If the task-based models and the related parameters are defined by one of the entities (e.g., the WTRU or NW) before performing training, synchronizing the tasks and parameters may need minimal data exchange. If the task-based models and the related parameters can be defined by one of the entities (e.g., the WTRU or NW), for example, after performing training, minimal data exchange may be needed but the 2 trainings may become sequential in nature.

Common Configurations for interoperability may be described herein. AIML model configuration and assumptions may be described herein.

The WTRU may be configured with an AIML encoder to be used for the CSI generation part, wherein the configured encoder may satisfy one or more interoperability conditions and/or parameters. This is to ensure proper operation/pairing between the WTRU AIML encoder model and the NW AIML decoder model, with limited share of information about the models at both communication nodes. For example, the conditions/parameters may include the bottle-neck dimension size, quantization type, number of quantization bits, the input data type, (e.g., CSI or possibly preprocessed version). In an implementation, the WTRU encoder model may be explicitly configured, (e.g., using model ID), wherein each model is defined by one or more parameters, (e.g., bottleneck size, quantization), input data type. In another implementation, the WTRU encoder model may be implicitly configured, (e.g., as a function of the allocated uplink CSI payload, channel conditions, number of configured MIMO layers, number of transmit/receive antennas, and/or configured BWP).

While CSI compression is used herein as an example use-case, the implementations herein may not be limited to CSI compression and should be broadly considered applicable to any use-case in which two-sided model framework is used, with separate training of the encoder and decoder models and with limited share of information about the encoder and decoder models, (e.g., architecture, training procedure, etc.) at the two nodes.

Configuration of various datasets may be described herein. For example, the configuration may be type, content, and/or format. The WTRU may be configured with a plurality of datasets in support of AIML encoder model training while ensuring interoperability with a separately trained AIML decoder model. Each dataset may be associated with at least a dataset index/ID, a dataset applicable condition, and/or a dataset configuration parameter.

For a dataset index/ID, the dataset ID may be used to identify a pre-existing dataset along with one or more associated parameters, e.g., defined format, CSI type (e.g., full CSI, eigenvector-domain samples, beam-domain samples, and/or delay-domain samples)

For dataset applicable conditions, the conditions may include a set of possible CSI measurements range at which the dataset is generated. For example, the measurements type may include reference signal received power (RSRP), reference signal received quality (RSRQ), signal-to-noise ratio (SNR), received signal strength indicator (RSSI), RI, delay spread, Doppler shift, angle of arrival (AoA) range, angle of departure (AoD) range.

For dataset configuration parameters, for example, dataset configuration parameters may include at least one of a configuration parameter. For example, a configuration parameter may be number of transmit/receive antenna ports, bandwidth part (BWP), frequency region, number of beams in case of beam domain samples, number of delay tabs in case of delay-domain samples. In an option, the dataset configuration may include at least one of a scenario, e.g., link-type (Los and/or NLOS), indoor and/or outdoor, moving and/or non-moving WTRU and associated speed, cell-edge users and/or cell-center users). The dataset may include one or more functions (e.g., preprocessing/post-processing, transformation applied to data, etc.). The dataset may include channel model parameters, e.g., channel model (e.g., UMa, Umi, ray tracing, and/or field data,).

Performance metric/requirement configuration may be described herein. In an implementation, the WTRU may be configured with a performance metric/requirement associated with each dataset. For example, the metric may be configured as cosine similarity or variations thereof. In another implementation, the metric may be normalized mean square error. In an implementation, the metric may be Euclidean distance. In an implementation, the metric may be a projection of encoded test samples on the encoded anchor vectors and compare the resulting projection with a configured threshold. The WTRU may measure the configured metric between the encoded anchor vectors and a few encoded test samples from the dataset, wherein the encoded test samples and the encoded anchor vectors are different.

Configurations for task based interoperability may be described herein. The WTRU may be configured with one or more tasks, e.g., N tasks, labeled as T₁, . . . , T_{N}, to be utilized for the WTRU side model training. The tasks may be used/enforced during the encoder training to ensure interoperability with a separately trained AIML decoder model utilizing the same task used by the encoder. Each task may be associated with a model, referred to as a task model. The task model may pretrained either by WTRU or NW. The task model may be trained along with the encoder or decoder model. If the task model is trained by the WTRU, then the WTRU may be configured to share the task model upon training, otherwise the WTRU may be configured by the NW. The set of tasks may be dependent on the use-case in which the two-sided model is used for. The task, Tᵢ, may be associated with one or more of a task index/ID, a subset of dataset, a subset of models, a regularization factor λᵢ, and/or a loss function Lᵢ for the regularization factor. The task ID may be used to identify a specific task associated with a specific use-case. The task Tᵢ may be used for training with samples corresponding to the subset Aᵢ⊂A, where A is the complete dataset. The task Tᵢ may be used along with training AIML models corresponding to the subset Mᵢ⊂M, and M may be the set of available AIML models.

For example, for the CSI compression use-case, the few examples of tasks may include channel parameter estimation, multipath estimation, beamforming, etc. More generally, depending on the use case one or more tasks can be configured which takes as an input from the latent space of the AIML model (e.g., WTRU side model) associated with the use case (e.g., compression), apply a transformation (e.g., using a task model) and produce an output. A loss function may be defined for the task model to ensure that the latent space can accomplish the task. For example, the loss function may be the difference between task model output and a label. Eventually the AIML model for the use case may be trained such that it can minimize the loss function defined for the use case while also (e.g., via regularization) minimizing the loss function defined for the task model associated with the use case. Few examples of tasks for the CSI compression use case are described herein, including, for example, channel parameter estimation, multipath estimation, and/or beamforming estimation. These should be considered as examples, and may not limit the implementations in this disclosure. The task may be configured to perform a transformation of a latent space to a different domain.

In some examples, the WTRU may be configured with a task of channel parameter estimation. For this task, the task based model may take as input the channel matrix Hᵢ in the latent space (e.g., after being mapped through the encoder) Eᵢ(Hᵢ). In one example, the task-based model may be a deep neural network consisting of a fully connected layer followed by a reshaping layer followed by a stack of convolutional neural network layers and finally, an output fully connected layer. The output dimension of the output fully connected layer may be equivalent to the number of parameters associated with the channel. For example, if the model is expected to predict the parameters (e.g., four parameters: azimuth angle of arrival, azimuth angle of departure, gain and doppler) associated with the top 5 multipaths, then the output dimensions of the model may be 20 (4×5). Let T₁(⋅) be the task based model associated with channel parameter estimation and

$${O}_{1}^{i}$$

be the output label associated with the input channel sample, Hᵢ, then the loss associated with the task may be given as

$${L}_{1} = {\vert {T}_{1} ( {E}_{1} ( {H}_{i} ) ) - {O}_{1}^{i} \vert}_{F} .$$

In some examples, the WTRU may be configured with a task of multipath estimation. For this task, the task based model may take as input the channel matrix Hᵢ in the latent space (after being mapped through the encoder) Eᵢ(Hᵢ). In one example, the task-based model may be a deep neural network consisting of a fully connected layer followed by a reshaping layer followed by a stack of convolutional neural network layers and finally, an output fully connected layer. The output dimension of the output fully connected layer may be 1, where the output of the model is expected to indicate the number of multipaths in the channel.

In another implementation, the WTRU may be configured with a task of codebook based beamforming. For this task, the task based model may take as input the channel matrix Hᵢ in the latent space (e.g., after being mapped through the encoder) Eᵢ(Hᵢ). In one example, the task-based model maybe a deep neural network consisting of a fully connected layer followed by a reshaping layer followed by a stack of convolutional neural network layers and finally, an output fully connected layer. The output of the model may be expected to indicate the index of the best transmit beams, where the index corresponds to the index of the beam in a pre-defined codebook (e.g. DFT codebook). The output of the neural network maybe represented in a one hot encoding format. Thus, for a codebook with B1 transmit beams, the neural network output may have a dimensionality of B1. The output layer of the neural may have a soft max operator indicating the best transmit beam.

Self-supervised and reference encoder/decoder tasks are described herein. In an implementation, the WTRU may be configured to use a self-supervised task wherein the WTRU applies a specific structure on the channel and then enforce that task during training. For example, the self-supervised task may represent a rotation of the channel and the WTRU may use the associated loss to capture the rotation effect. For example, the self-supervised task may represent adding a Doppler to the channel and the WTRU may use the associated loss as a Doppler estimation. Unlike the tasks discussed earlier (e.g., channel parameter estimation, multipath estimation, beamforming estimation, etc.) for a self-supervised task, the task-based model may not need to be configured with any specialized datasets or output labels. This is because for these tasks, the output labels may be generated by the WTRU (e.g., training entity). For example, in the Doppler estimation task, the WTRU may apply a doppler phase shift, for example, corresponding to 30 kmph WTRU speed, to the input channel sample Hᵢ before passing it through the encoder. In the encoded data space Eᵢ(Hᵢ). the objective of the task based neural network model would be to estimate the speed as 30 kmph. This doppler or speed estimation model may be a pre-configured model or may be trained at the WTRU in a self-supervised fashion.

The WTRU may be configured with a reference encoder/decoder and use the reference encoder/decoder as means for latent space alignment. For example, the WTRU may include a loss function term that defines a relation between the latent space of the trained encoder and the reference encoder/decoder, wherein the task is modeled through the reference encoder/decoder loss function.

Performance metric and/or requirement for each task is described herein. In an implementation, the WTRU may be configured with a performance metric and/or requirement associated with each task model. For example, the metric may be configured as cosine similarity or variations thereof. For example, the metric may be normalized mean square error (NMSE). For example, the metric/requirement may be a classification accuracy. The WTRU may be configured with a performance threshold for each metric associated with each task, wherein the threshold is used to evaluate the task model performance. The task model performance may represent an implicit measure of the latent space alignment and compatibility of WTRU-side encoder and NW-side decoder. For example, if the measured performance metric satisfies the threshold condition, then the task model may be valid to use for ensuring interoperability between the WTRU-side encoder and NW-side decoder. The WTRU may be configured to report the performance metric associated with the model task, wherein the indicated value may either be Boolean (e.g., below/above the threshold) or in absolute format.

Methods and apparatus described herein may include WTRU/NW side model training. One or more methods herein are described in terms of encoder/decoder of an autoencoder architecture as examples, but the solutions may be more generally applicable to any type of AIML model architecture. Herein the term encoder, decoder may be used interchangeably with AIML model. One or more methods herein are described in terms of gNB/NW, but the solutions may be more generally applicable to any type of transmission/reception node (e.g., WTRU).

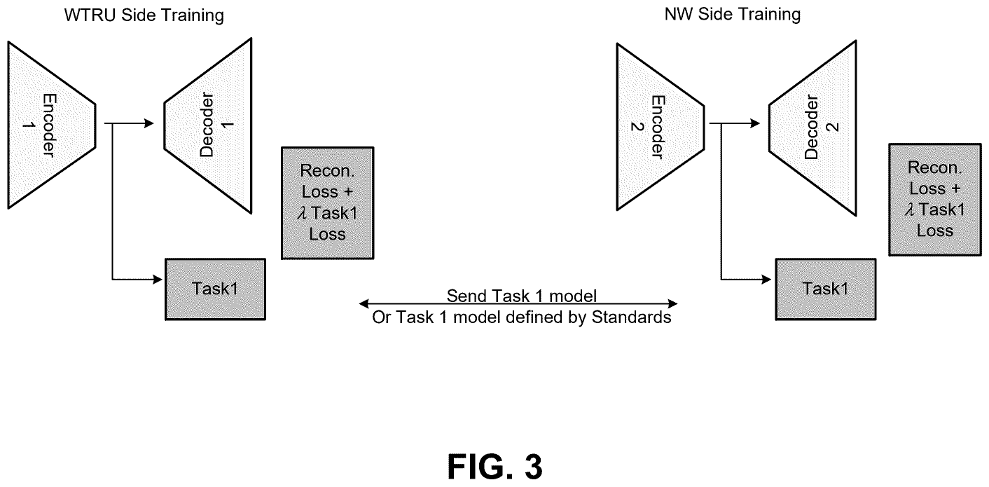

FIG. 3 is a diagram illustrating an example of how a WTRU and NW can train their respective encoder-decoder model with a reconstruction loss and a task related loss. The shared/common task and the task related loss may provide interoperability between the WTRU side and NW side. In an implementation, the WTRU may be configured to perform the training of the WTRU side model. The WTRU may utilize a task based regularization for the model training to ensure interoperability with the gNB side model.

Task Based Training is described herein. In one implementation, the WTRU may be configured with one or more pre-trained task-based models [T₁, . . . Tⱼ, . . . , T_{N}] where the task based models may typically operate in the latent/compressed domain. But in some scenarios, the task-based models may also operate in the input or reconstructed data domains. The WTRU may train its encoder model E₁ inconjunction with a decoder model D₁ to minimize the reconstruction loss. Further, the WTRU may also utilize the one or more specified tasks and task based models Tⱼ and their corresponding losses to train the encoder model. Given a dataset, DS1, with N1 samples, where the i-th input sample is given by Hᵢ and the corresponding output for the task Tⱼ is

$${O}_{i}^{j} .$$

An example loss function for the UE based training may be:

$$\frac{1}{N 1} {\sum }_{i = 1 : N 1} {\vert {D}_{1} ( {E}_{1} ( {H}_{i} ) ) - {H}_{i} \vert}_{F}^{2} + {{λ}_{1} ( {T}_{1} ( {E}_{1} ( {H}_{i} ) ) - {O}_{i}^{1} )}^{2} + … + {λ}_{j} ( {T}_{j} ( {E}_{1} ( {H}_{i} ) ) - {O}_{i}^{j} )$$

The WTRU may continue training until the stopping criterion or minimum required performance KPI associated with the reconstruction performance and each of the tasks are met. In another implementation, the WTRU may choose to train the encoder model E₁ directly with task-based models [T₁, . . . Tⱼ, . . . , T_{N}], without employing a decoder model. Thus, an example loss for the WTRU side encoder training may be of the form:

$$\frac{1}{N 1} {\sum }_{i = 1 : N 1} {{λ}_{1} ( {T}_{1} ( {E}_{1} ( {H}_{i} ) ) - {O}_{i}^{1} )}^{2} + … + {λ}_{j} ( {T}_{j} ( {E}_{1} ( {H}_{i} ) ) - {O}_{i}^{j} )$$

The WTRU may be configured with a task-based model corresponding to a reference encoder model, R^{E}. The WTRU may then opt to train its encoder model, E₁, to minimize a predefined loss between mapping of the input data sample through the encoder E₁ and the reference encoder R^{E}. In one example, the WTRU may utilize a means square error (MSE) based loss:

$$\frac{1}{N 1} {\sum }_{i = 1 : N 1} {\vert {E}_{1} ( {H}_{i} ) - {R}^{E} ( {H}_{i} ) \vert}_{F}^{2}$$

The WTRU may utilize a p-th norm based loss:

$${\sum }_{i = 1 : N 1} {\vert {E}_{1} ( {H}_{i} ) - {R}^{E} ( {H}_{i} ) \vert}_{p}$$

The WTRU may utilize a cosine similarity based loss:

$${\sum }_{i = 1 : N 1} \frac{R e ( {{E}_{1} ( {A}_{1} )}^{T} {E}_{1} ( {H}_{i} ) )}{‖ ( {E}_{1} ( {A}_{1} ) ‖ ‖ {E}_{1} ( {H}_{i} ) ‖}$$

The WTRU may train an encoder-decoder (E₁, D₁) pair to minimize the reconstruction loss while adding a regularization associated with the reference encoder. Thus, in one example the WTRU may utilize a loss:

$$\frac{1}{N 1} {\sum }_{i = 1 : N 1} {\vert {D}_{1} ( {E}_{1} ( {H}_{i} ) ) - {H}_{i} \vert}_{F}^{2} + {λ ( {E}_{1} ( {H}_{i} ) - {R}^{E} ( {H}_{i} ) )}^{2} .$$

The WTRU may be configured with a task-based model corresponding to a reference decoder model, R^{E}. Thus, the WTRU may train the encoder model E₁, to minimize a reconstruction loss between the input sample, Hᵢ, and the input sample's mapping through the encoder E₁ and the reference decoder R^{D}. In one example, the WTRU may utilize a MSE based loss:

$$\frac{1}{N 1} {\sum }_{i = 1 : N 1} {( {R}^{D} ( {E}_{1} ( {H}_{i} ) ) - {H}_{i} )}^{2}$$

The WTRU may be configured with a task-based model corresponding to a reference encoder-decoder model pair, R^{E}, R^{D}. Thus, the WTRU may have multiple options to train its encoder model E₁. In one setup, the WTRU may utilize the reference encoder model to minimize a predefined loss between mapping of the input data sample through the encoder E₁ and the reference encoder R^{E}. In another setup, the WTRU may utilize just the reference decoder model to minimize a reconstruction loss between the input sample, Hᵢ, and the input sample's mapping through the encoder E₁ and the reference decoder R^{D}. In another setup, the WTRU may train its own encoder-decoder pair so as to minimize the loss between the two reconstructed outputs and also minimize the loss between the latents. Thus, in one example the WTRU may utilize a loss:

$$\frac{1}{N 1} {\sum }_{i = 1 : N 1} {( {D}_{1} ( {E}_{1} ( {H}_{i} ) ) - {R}^{D} ( {R}^{E} ( {H}_{i} ) ) )}^{2} + {λ ( {E}_{1} ( {H}_{i} ) - {R}^{E} ( {H}_{i} ) )}^{2} .$$

The WTRU may select a self-supervised task for encoder training and may indicate to the NW the specifics of the self-supervised task and model without explicitly sharing the trained self-supervised model. In the case of channel/CSI inputs, an example of the self-supervised task would be to apply doppler phase shifts to the channel specific WTRU speed and then estimate the WTRU speed in the latent or compressed domain (at the encoder output).

Implementations related to sequential training may be described herein. The WTRU may choose to define one or more tasks to be utilized for encoder-decoder training and the corresponding the task-based models to be utilized for training. Further, the WTRU may also train the task-based models [T₁, . . . Tⱼ, . . . , T_{N}]. The WTRU may then transmit these task-based models to the NW and may indicate to the NW that these task models should be utilized for NW side model training to ensure interoperability.

The NW may choose to define one or more tasks to be utilized for encoder-decoder training and the corresponding the task-based models to be utilized for training. Further, the NW may train the task-based models [T₁, . . . Tⱼ, . . . , T_{N}]. The NW may then transmit these task-based models to the WTRU and may indicate to the WTRU that these task models should be utilized for WTRU side model training to ensure interoperability.

The NW and WTRU both may choose to define one or more tasks of their own choosing to be utilized for encoder-decoder training and the corresponding the task-based models to be utilized for training. Further, the NW and WTRU may train the task based models

$$[ {T}_{1}^{N W} , … {T}_{j}^{N W} , … , {T}_{N}^{N W} ] and [ {T}_{1}^{U E} , … {T}_{j}^{U E} , … , {T}_{N}^{U E} ] ,$$

respectively. The NW and WTRU may utilize their own task-based models for the first round of training of their encoder-decoder models. The NW and WTRU may then transmit these task-based models to the WTRU and NW, respectively. As a second round of model training, the NW and WTRU may both fine tune their models with the task-based models received from the other entity. During the fine tuning process, the NW and WTRU may also utilize their own task based models.

Implementations related to WTRU-NW Compatibility and Performance monitoring are described herein. One or more implementations herein may enable the transmitter and receiver to train the models independently and use those models for joint inference. The WTRU may be configured to perform one or more actions to enable interoperability between two AIML models. For example, a first AIML model may be at the WTRU and a second AIML model may be at the network. The WTRU may transmit interoperability report wherein the interoperability report may contain one or more elements that characterize the latent space of the AI/ML model at the WTRU. The interoperability information may be shared from one entity to the other. In one example, the WTRU may receive interoperability configuration from the network. The WTRU may be configured to transmit interoperability report to the network. The interoperability configuration and/or interoperability report may include one or more of a unique identify associated with the task used for training the AIML model, datasets used for training the AIML model, plurality of test cases, additional training related parameters, and/or model performance and KPI.

The interoperability configuration and/or interoperability report may include a unique identity associated with the task (e.g., task identity/index) used for training the AIML model. In an implementation, the WTRU may be configured with plurality of tasks. The implementation may train the AIML model on a subset of tasks. The implementation may report task ID(s) associated with subset of tasks used for model training in the interoperability report and/or configuration. In an implementation, the WTRU may report the task IDs for which the WTRU is capable of performance monitoring. In one implementation, the tasks and their task index/IDs may be predefined. For example, the task ID may uniquely identify the details of the task such as the input to the model and/or optionally pre-processing, the expected output from the model and/or optionally postprocessing, loss function, and/or the performance requirement. The details of the task may be exchanged as task meta information wherein the meta information may include the details/configurations for input to the model and/or optionally pre-processing, the expected output from the model and/or optionally postprocessing, loss function and/or the performance requirement.

The dataset(s) used for training the AIML model may include the parameters used for generating the dataset(s) or more explicitly the dataset ID(s) used for training. Possibly the dataset(s) may be associated with task(s) configured for training.

In an implementation, the WTRU may be configured with plurality of test cases. Herein each test case may include one or more of initial conditions, applicability conditions, datasets (including input, output), tasks, performance requirements etc. The WTRU may indicate the results of the test case(s) on the trained AIML model. Possibly such indication may enable the interoperability. For example, the interoperability may be to identify a corresponding AIML model at the network side to interoperate with WTRU side model. For example, the WTRU may indicate the test case(s) on which the trained AIML model passed. For example, the WTRU may indicate the test case(s) for which the trained AIML model exceeds the preconfigured performance requirements. For example, the WTRU may indicate the test case(s) for which the trained AIML model produces the expected output. For the purposes of signaling, the test case(s) may be grouped into subsets and the WTRU may indicate the granularity in terms of subset of test case(s). For example, the WTRU may report the average performance for the subset of test case(s).

In an implementation, the WTRU may be configured generate output associated with one or more tasks for the trained AIML model. For example, the WTRU may generate output for a preconfigured dataset for a plurality of tasks. The WTRU may be configured to report the generated output of the AIML model to the network.

Additional training related parameters may include one or more of training hyperparameters (e.g., random seed, optimizer etc.), model hyperparameters, architecture/backbone, encoder complexity information (e.g. number of parameters, FLOPS), num layers, regularization and/or parameters thereof, and/or training loss function.

Model performance and KPI may include information about the metrics used to gauge model performance and/or the performance values achieved by the encoder. In an implementation, the interoperability report may include performance on each of the reported tasks.

In an implementation, the WTRU may be configured to transmit an indication of one or more reference model(s) associated with training the AIML model. For example, for the purpose of training a first AIML model, the WTRU may be configured with plurality of reference models (e.g., reference model A, reference model B so on up to reference model z). For example, the WTRU may select a subset of reference model(s) (e.g., reference model x, reference model y and/or reference model z) to enable training of the first AIML model. Such reference models may be selected based on applicability conditions. Such reference models may be selected based on WTRU capability. Possibly such reference models may be selected based on performance target. Such reference models may be selected based on supported model architectures and/or hardware support. Such reference models may be selected based on tradeoff between size, complexity, latency, cost and/or power consumption. The WTRU may transmit an indication of reference model(s) used for training for first AIML model. Such indication may enable the interoperability with a NW side model.

The WTRU may transmit interoperability report for the available models at the WTRU. In another implementation, the WTRU may be configured to transmit interoperability report for a subset of models, wherein the subset of models may be explicitly configured for interoperability reporting. The WTRU may transmit interoperability report based on gNB request. The subset of models may be currently activated models. A subset of models may be preconfigured for performance monitoring. A subset of models may be preconfigured for WTRU capability reporting. In an implementation, the WTRU may be configured to ensure that the WTRU side model is compatible with NW side model. The WTRU may be configured to check the compatibility of its model with NW side model before activation of the model. The WTRU may be configured to check the compatibility of its model with NW side model before monitoring performance of the model. The WTRU may be configured to check the compatibility of its model with NW side model before selection of the model for inference. The WTRU may be configured to perform inference with WTRU-side AIML model to verify compatibility with the NW-side AIML model.

An example implementation may include compatibility Testing for Task Based Training. The WTRU may utilize the trained encoder, E₁, to encode a pre-defined test dataset to estimate the dataset in the latent space (or compressed domain) E₁(Hᵢ). On the encoded data, for each task, the WTRU may utilize the task-based models to generate the task outputs Tⱼ(E₁(Hᵢ). For a subset of the tasks, the WTRU may share these task outputs on the pre-defined test dataset with the NW. The NW may further utilize its own encoder, E₂, corresponding to the NW side decoder D₂, and generate the task-based outputs for the pre-defined test datasets and compare those against the outputs from the WTRU. In one example, the NW may evaluate a squared error loss between the 2 outputs and see if the squared error loss is below a threshold for each of the tasks to decide if the WTRU and NW models are compatible. This evaluation may be express in this formula:

$${\sum }_{i} \qquad {\vert {T}_{j} ( {E}_{1} ( {H}_{i} ) - {T}_{j} ( {E}_{2} ( {H}_{i} ) \vert}_{F}^{2} \qquad < {Threshold}_{j} .$$

The WTRU may utilize a set of pre-defined test related tasks and their corresponding models,

$$[ {T}_{1}^{t} , … , {T}_{N}^{t} ]$$

for checking the performance of the WTRU side model. The set of test related tasks may not be limited to the set of tasks utilized for model training. The WTRU may measure the performance of the WTRU encoder (e.g., the encoded dataset) on each of these tasks and indicates the subset of tasks on which the WTRU model achieved at least the minimum performance threshold. The NW may then select a decoder model (e.g., and its corresponding encoder model) that also satisfies at least the same set of test tasks.

Where the WTRU and NW train their own self-supervised tasks for encoder/decoder training or wherein they update the pre-defined tasks during the encoder/decoder training, the WTRU may share the updated/trained task model with the NW. The NW may compare the WTRU side task model with its own task model to determine the compatibility of the WTRU encoder with the NW decoder. In one example, the NW may directly compare the WTRU and NW task models by comparing the value of the model weights. In another example, the NW may compare the final or intermediate outputs of the WTRU and NW models to determine compatibility.

The WTRU may monitor performance of AIML model as a function of one or more of the preconfigured tasks. In one or more methods herein, the solutions described for compatibility and/or interoperability may be also applied for performance monitoring. For example, the WTRU may be configured to transmit the performance monitoring report and/or metric with the contents described for compatibility report. The compatibility report may be transmitted as part of the WTRU capability, functionality identification, model identification and/or WTRU assistance information procedures. The performance monitoring report may be transmitted during performance monitoring procedure.

The WTRU may be configured to monitor performance of the AIML model as a function of preconfigured tasks associated with model training. For example, the WTRU may be configured to measure the performance of AIML model on one or more of the tasks. For example, the WTRU may infer the model performance of a use case (e.g., CSI compression) as a function of model performance on one or more of preconfigured tasks (e.g., defined for interoperable model training). For example, the WTRU may be configured with one or more tasks T₁, . . . , T_{N}, and for each task an associated performance threshold P₁, . . . , P_{N}, The WTRU may determine that the performance of AIML model for a use case (e.g., CSI compression) is below a threshold when the performance of N tasks on that AIML model is below the configured performance threshold. The WTRU may be configured to transmit the performance report periodically. The WTRU may be configured to transmit performance monitoring report when the performance of the AIML model is below a preconfigured threshold. The WTRU may be configured to transmit performance monitoring report when the performance of the AIML model is below a preconfigured threshold. The WTRU may be configured to report the performance of the AIML model on the tasks. The WTRU may be configured to report the performance of AIML model on different tasks with different periodicity. For example, an AIML model performance on subset of tasks (T1, . . . TH) may be configured to be reported more frequently. For example, an AIML model performance on subset of tasks (TK, . . . TL) may be configured to be reported less frequently. For example, the WTRU may report AIML model performance on a second subset of tasks (TK, . . . TL) when the performance of AIML model on the first subset of tasks (T1, . . . , TH) is below a threshold.

The WTRU may be configured to perform model selection for inference as a function of the AIML model performance on one or more of the configured tasks. For example, a subset of tasks (T1, . . . , TS) and performance thresholds (P1, . . . PS) may be configured for model selection. The WTRU may be configured to select an AIML model for inference, for example, when the AIML model performance on the tasks (T1, . . . TS) exceeds respective thresholds (P1, . . . PS). In one implementation, if multiple AIML models satisfy the condition, then the WTRU may be configured to select the model that has the best performance on most of the preconfigured tasks. In another implementation, if multiple AIML models satisfy the condition, then the WTRU may be configured to select the model that has the best average performance on the preconfigured tasks. In another implementation, if multiple AIML models satisfy the condition, then the WTRU may be configured to select the AIML model whose lowest performance on preconfigured tasks is the maximum among the AIML models.

The WTRU may be configured to fallback to non-AIML operation if one or more triggers for transmission of performance report is triggered and no available AIML model at the WTRU satisfies the performance requirement.

For the example of CSI use case, upon activation of AIML model for inference, during each reporting instance (e.g., CSI feedback), the WTRU may derive encoded input Hᵢ (e.g., Channel matrix) in latent space—E(Hᵢ). The WTRU may apply preconfigured quantization to the encoded representation E(Hᵢ). The WTRU may report the quantized representation as compressed CSI feedback.

Task based interoperability is described herein. Method for training 2-sided model (e.g., for CSI compression) where the WTRU trains the WTRU-side model (NW trains the NW-side model) independently to satisfy a preconfigured performance condition may be described herein. WTRU/NW may achieve interoperability for inference by utilizing a task-based regularization during the model training. WTRU may use the task-based regularization for interoperability and/or performance monitoring.

The WTRU may be configured with a plurality of datasets, one or more tasks, performance metric/requirement for each task, and/or model related parameters. Each dataset in the plurality of datasets may be associated with one or more of deployments, vendors, WTRU/NW additional condition etc. For example, each dataset may be associated with a Dataset ID. Each dataset may be associated with one or more applicable conditions. Each dataset may be configured as distribution of parameters (for example, each dataset may be expressed as fundamental channel parameters, like decomposed channel, and expressed in terms of 3GPP channel model parameters like UMa/CDL/etc., doppler, delay, etc.)

A single task T1 or a set of tasks [T1, T2, . . . TN] maybe utilized for WTRU side model training. The task may be a generic/reference task that can be performed with the data. For example, for the CSI case, the task may be channel parameter estimation, multipath estimation, beamforming, channel charting etc. Examples of self-supervised tasks may be adding doppler phase shifts for a WTRU speed to channel and predicting the doppler shift or WTRU speed. Compression may be considered as the task. For example, a proxy/reference auto-encoder, or reference encoder or a reference decoder may be pre-trained for compression.

Each task Ti may be accompanied with a logical identification, a model Mᵢ, a regularization factor λᵢ, and/or a loss function Lᵢ for the regularization. The model may be pre-trained or may be trained along with the auto-encoder training.

Each task may be further associated with a subset of the dataset, such that the task Ti is used for training with samples corresponding to the subset Aᵢ⊂A, where A is the complete dataset. For each task Ti, the WTRU may be also configured with the training output labels corresponding to Aᵢ or an algorithm to obtain labels using Aᵢ. For each task, the model Mᵢ may be pre-trained or maybe trained along with the training of the encoder model.

The WTRU may be configured with performance metric/requirement for each task, like a key performance indicator (KPI). Examples of metric for performance of each of the Ti tasks may be normalized mean square error (NMSE), squared generalized cosine similarity (SGCS), and/or classification accuracy. A KPI may be a minimum performance threshold for each metric associated with each task.

The WTRU may be configured with model related parameters. Examples of model related parameters may be latent dimension, loss function for auto-encoding, and/or performance metric/requirement for each task. Examples of metric for performance of the autoencoder may be normalized mean square error (NMSE), squared generalized cosine similarity (SGCS), etc. A KPI may be a minimum performance threshold for each metric.

The WTRU may train AIML model based on task-based regularization. The WTRU may train its encoder model directly with the task-based model, or the WTRU may train the encoder with another decoder model while also using the task-based model regularization. For example, in the case of a generic task. The WTRU may also update or train the task-based models along with encoder training. Examples of the WTRU may train its encoder model directly with the task-based model are described herein. For example, if the refence task is a decoder model, direct training with reference decoder may be performed. In this example, a loss function may be

$$\frac{1}{N 1} {\sum }_{i = 1 : N 1} {\vert ( {R}^{D} ( {E}_{1} ( {H}_{i} ) ) - ( {H}_{i} ) ) \vert}_{F}^{2} .$$

In another example, if the reference task is a reference encoder, direct training may be performed to minimize the loss in latent space. In this example, a loss function may be

$$\frac{1}{N 1} {\sum }_{i = 1 : N 1} {\vert ( {E}_{1} ( {H}_{i} ) - {R}^{E} ( {H}_{i} ) ) \vert}_{F}^{2} .$$

For example, if the reference task is an auto-encoder (REF_AE), the WTRU may train its encoder model directly with the task-based model to directly minimize the loss between (AE(H)−REF_AE(H).

The WTRU may transmit an indication related to compatibility (or interoperability info in model identification) of WTRU side model with respect to NW side models. The indication may include identity of one or more tasks used for regularization during the WTRU side model training, identity of datasets used for training the WTRU-side model, identity of test case(s) on which the WTRU-side model performance was validated (where the WTRU may send reconstruction minimum performance thresholds corresponding to the test samples), and/or identity of reference model(s) used for regularization during WTRU side model training. For each of the tasks, the WTRU may send the output of the task-based model for a predefined performance test dataset. The NW may compare and determine if the WTRU output is similar to the NW output. The WTRU may send the updated or trained task-based model to the NW where the NW may compare the WTRU side task-based model with its own task-based model either directly or the outputs of these models. The WTRU may report the training strategy (or any deviations from the training strategy). The training strategy may include task training, and/or decoder training. The train strategy or deviations from the training strategy may include tasks used for training and for how many steps/updates.

Upon activation of AIML model for inference, during each reporting instance (e.g., CSI feedback), the WTRU may derive encoded input Hᵢ (e.g., Channel matrix) in latent space like E(Hᵢ), the WTRU may apply preconfigured quantization to the encoded representation E(Hᵢ), and/or the WTRU may report the quantized representation as compressed CSI feedback.

The WTRU may do performance monitoring based on preconfigured task(s). The WTRU may use the actual CSI sample and the compressed representation to measure the task performance. The WTRU may trigger performance monitoring report/Fallback/Model switching if the task performance is lower than a threshold.

Implementations described herein may contain various benefits. Implementations described herein may avoid drawbacks of the current training methods, where the encoder-decoder models either need to be trained together, or large amounts training data or gradient data transfer has to be undertaken.

The WTRU side and NW side models may be independently trained, and interoperability between the 2 models may be ensured with minimal or no data exchange.

In some examples, there may be no constraints on the model architecture, loss functions or any training parameters. Further, for a 2-sided model (e.g., such as an encoder-decoder), no prior knowledge (e.g., or coordination) about the model architecture, and other training parameters may be needed.

If the task-based models and the related parameters are pre-defined as part of the standards, no data exchange may be needed to ensure interoperability. If the task-based models and the related parameters are defined by one of the entities (e.g., the WTRU or NW) before performing training, synchronizing the tasks and parameters may need minimal data exchange. If the task-based models and the related parameters can be defined by one of the entities (e.g., the WTRU orNW) after performing training, minimal data exchange may be needed but the 2 trainings may become sequential in nature.

1. A wireless transmit/receive unit (WTRU) comprising:
a processor and memory, the processor and memory configured to:
receive configuration information from a network, the configuration information comprising a task associated with a WTRU-side model and a performance metric threshold related to the task;
train a WTRU-side model for performing a use case based on regularization using the task;
determine that the performance metric threshold is met by a performance of the WTRU-side model on the task; and
send, to the network, an indication of the task based on the performance metric threshold being met by the performance of the WTRU-side model on the task.

2. The WTRU of claim 1, wherein the use case comprises CSI compression; and
wherein the processor and memory are further configured to:
determine an encoded channel matrix in a latent space;
determine a quantized channel matrix; and
send a report to the network, wherein the report comprises the indication of the task, and wherein the indication of the task indicates the quantized channel matrix as compressed CSI feedback.

3. The WTRU of claim 2, wherein the processor and memory are further configured to:
determine that the performance metric threshold is met by the performance of the WTRU-side model on the task based on measured CSI feedback and the compressed CSI feedback.

4. The WTRU of claim 3, wherein the processor and memory are further configured to:
trigger a performance monitoring report, a fallback, or a model switching if the performance of the WTRU-side model on the task is less than the performance metric threshold.

5. The WTRU of claim 1, wherein the task associated with the WTRU-side model comprises a supervised or unsupervised task that is performed on one or more data sets, a self-supervised task that is associated with a structure being applied to the channel, or a compression task associated with a reference encoder or a reference decoder.

6. The WTRU of claim 1, wherein the task is associated with a logical identification, a model, a regularization factor, or a loss function associated with regularization.

7. The WTRU of claim 1, wherein the use case comprises CSI compression.

8. The WTRU of claim 1, wherein the performance metric threshold comprises a normalized mean square error (NMSE) threshold, a squared generalized cosine similarity (SGCS) threshold, a classification accuracy threshold, or a key performance indicator (KPI) threshold.

9. The WTRU of claim 1, wherein the configuration information comprises an indication of a plurality of datasets that can be used for training the WTRU-side model, and wherein the processor is further configured to send, to the network, an indication of a dataset of the plurality of datasets that was used when the performance metric threshold is met by the performance of the WTRU-side model on the task.

10. The WTRU of claim 1, wherein the processor being configured to determine that the performance metric threshold is met by the performance of the WTRU-side model on the task comprises the processor being configured to determine that the performance metric threshold is met by a performance of a combination of the WTRU-side model and an additional WTRU-side model on the task.

11. A method implemented by a wireless transmit/receive unit (WTRU), the method comprising:
receiving configuration information from a network, the configuration information comprising a task associated with a WTRU-side model and a performance metric threshold related to the task;
training a WTRU-side model for performing a use case based on regularization using the task;
determining that the performance metric threshold is met by a performance of the WTRU-side model on the task; and
sending, to the network, an indication of the task based on the performance metric threshold being met by the performance of the WTRU-side model on the task.

12. The method of claim 11, wherein the use case comprises CSI compression, and wherein the method further comprises:
determining an encoded channel matrix in a latent space;
determining a quantized channel matrix; and
sending a report to the network, wherein the report comprises the indication of the task, and wherein the indication of the task indicates the quantized channel matrix as compressed CSI feedback.

13. The method of claim 12, further comprising:
determining that the performance metric threshold is met by the performance of the WTRU-side model on the task based on measured CSI feedback and the compressed CSI feedback.

14. The method of claim 13, further comprising:
triggering a performance monitoring report, a fallback, or a model switching if the performance of the WTRU-side model on the task is less than the performance metric threshold.

15. The method of claim 11, wherein the task associated with the WTRU-side model comprises a supervised or unsupervised task that is performed on one or more data sets, a self-supervised task that is associated with a structure being applied to the channel, or a compression task associated with a reference encoder or a reference decoder.

16. The method of claim 11, wherein the task is associated with a logical identification, a model, a regularization factor, or a loss function associated with regularization.

17. The method of claim 11, wherein the use case comprises CSI compression.

18. The method of claim 11, wherein the performance metric threshold comprises a normalized mean square error (NMSE) threshold, a squared generalized cosine similarity (SGCS) threshold, a classification accuracy threshold, or a key performance indicator (KPI) threshold.

19. The method of claim 11, wherein the configuration information comprises an indication of a plurality of datasets that can be used for training the WTRU-side model, and wherein the method further comprises sending, to the network, an indication of a dataset of the plurality of datasets that was used when the performance metric threshold is met by the performance of the WTRU-side model on the task.

20. The method of claim 11, wherein determining that the performance metric threshold is met by the performance of the WTRU-side model on the task comprises determining that the performance metric threshold is met by a performance of a combination of the WTRU-side model and an additional WTRU-side model on the task.
